(19) United States
(12) Patent Application Publication
(10) Pub. No.: US 2020/0110647 A1
(43) Pub. Date: Apr. 9, 2020

(54) TOPOLOGY-BASED PRESENTATION OF EXPERT TRIAGE WORKFLOWS

(71) Applicant: CA, Inc., New York, NY (US)

(72) Inventors: Benoit Christian Bernard Souche, San Jose, CA (US); Timothy Diep, Portsmouth, NH (US)

(21) Appl. No.: 16/154,806

(22) Filed: Oct. 9, 2018

(51) Int. Cl. G06F 11/07; G06F 3/0481; G06F 3/0484

(52) U.S. Cl. CPC G06F 11/079; G06F 11/0709; G06F 3/04847; G06F 11/0769; G06F 3/04817; G06F 11/0751

(57) ABSTRACT

A topology-based triage workflow service can display expert generated workflows in conjunction with a topology. A user can select a device experiencing an issue and can walk through a workflow for diagnosing an issue. The service analyzes the workflow to determine which components are related to each troubleshooting step and can highlight them within the topology to indicate to a user the relevant components. The service can also retrieve and display metrics relevant to each step in the workflow. As workflows are used, the service can track users' paths through workflows, troubleshooting success, and feedback. Based on the feedback, the application can improve workflows, suggest root causes of issues, or create automated scripts based on the most popular/successful workflows for solving particular issues.

### BACKGROUND

The disclosure generally relates to the field of data processing, and more particularly to computer and device management.

Information technology (IT) personnel are often relied upon to diagnose and troubleshoot issues in a system, such as device failures or slow response times. The IT personnel may be unfamiliar with a technical domain or lack the expertise for diagnosing an issue. Additionally, once an issue has been resolved, the IT personnel may lack a convenient way for recording the resolution for future use or passing the information on to other personnel.

### BRIEF DESCRIPTION OF THE DRAWINGS

Aspects of the disclosure may be better understood by referencing the accompanying drawings.

FIG. 1 depicts an example user interface for topology-based presentation of triage workflows.

FIG. 2 depicts an example user interface for a triage service which depicts a topology along with recommended triage workflows.

FIG. 3 depicts an example user interface for a triage workflow editor.

FIG. 4 depicts an example user interface for displaying performance metrics related to a triage workflow.

FIG. 5 depicts operations for a topology-based presentation of triage workflows.

FIG. 6 depicts a triage workflow which has been modified based on user feedback.

FIG. 7 depicts an example computer system with a topology based triage workflow service.

### DESCRIPTION

The description that follows includes example systems, methods, techniques, and program flows that embody aspects of the disclosure. However, it is understood that this disclosure may be practiced without these specific details. For instance, this disclosure refers to diagnosing issues in a computer network in illustrative examples. Aspects of this disclosure can be also applied to other systems which are monitored and triaged, such as oil and gas systems or manufacturing systems. In other instances, well-known instruction instances, protocols, structures and techniques have not been shown in detail in order not to obfuscate the description.

Overview

Retaining and sharing expert knowledge for diagnosing and troubleshooting issues in an IT environment can be difficult. There is a need for an application to allow a layman to walk through expert troubleshooting workflows and surface relevant data and components for diagnosis.

A topology-based triage workflow service can display expert generated workflows in conjunction with a topology. A user can select a device experiencing an issue and can walk through a workflow for diagnosing an issue. The service analyzes the workflow to determine which components are related to each troubleshooting step and can highlight them within the topology to indicate to a user the relevant components. The service can also retrieve and display metrics relevant to each step in the workflow. As workflows are used, the service can track users' paths through workflows, troubleshooting success, and feedback. Based on the feedback, the application can improve workflows, suggest root causes of issues, or create automated scripts based on the most popular/successful workflows for solving particular issues.

Example Illustrations

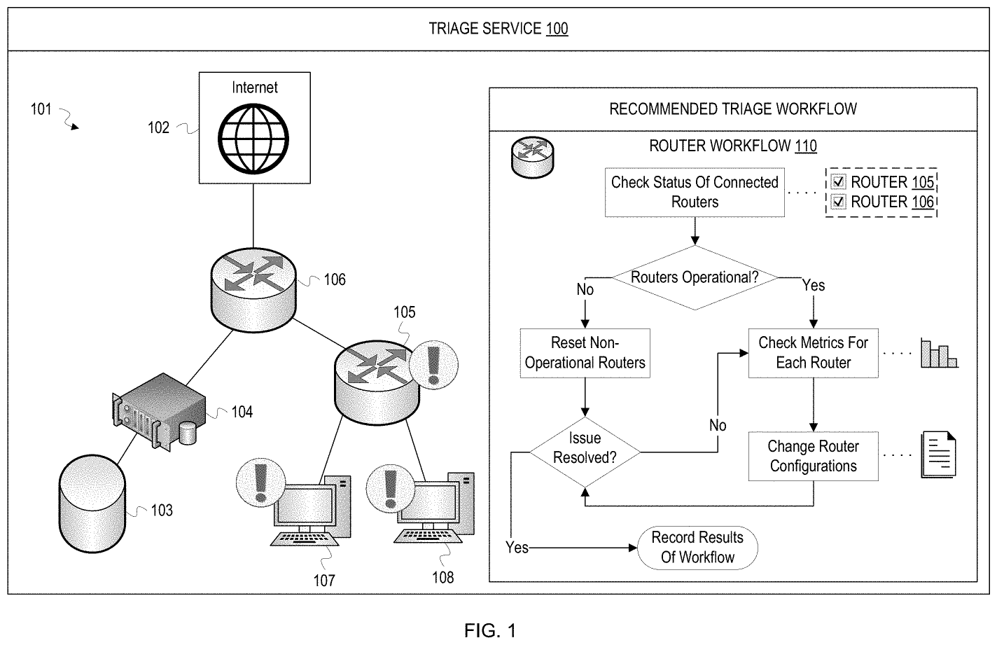

FIG. 1 depicts an example user interface for topology-based presentation of triage workflows. FIG. 1 depicts a triage service 100 which is part of a network management application. The triage service 100 may be executing on an administrator console or workstation. The triage service 100 includes a user interface for displaying a topology 101 and a router workflow 110. The topology 101 depicts elements for an internet connection 102, e.g. a wide area network connection, a database 103, a database management service (DBMS) 104, a router 105, a router 106, a computer 107, and a computer 108.

The triage service 100 can receive information from other network management services such as a topology discovery service and an event management service which processes events generated by devices in a network. For example, the topology discovery service may be a service which polls network devices through the simple network management protocol (SNMP) to discover connected devices and their layout. The triage service 100 utilizes topology information to generate the displayed topology 101. The triage service 100 can modify the topology 101 based on metric data and events received from an event management service. For example, the triage service 100 can change colors of edges/connections between components in the topology 101 based on an amount of traffic between the components, e.g., green to represent a low amount of traffic and yellow to represent a high amount of traffic. Also, the triage service 100 can update the topology 101 to depict devices which are currently experiencing an issue based on alarms or events received for a device. In FIG. 1, the triage service 100 has marked the router 105, the computer 107 and the computer 108 with an exclamation mark to indicate that these devices are experiencing an issue. For example, the devices may be unable to connect to the router 105 or may be unable to reach the internet 102 or the DBMS 104.

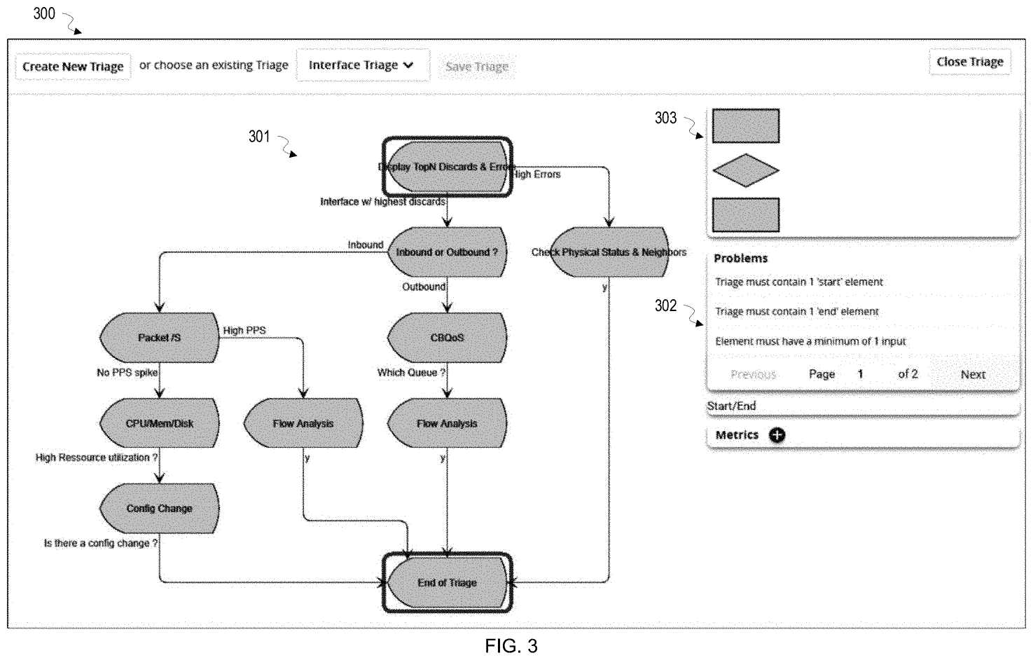

Based on detecting issues at the router 105 and the computers 107/108, the triage service 100 retrieves one or more previously generated workflows designed to guide an administrator through resolving the detected issues. The workflows may have been generated by one or more experts or by administrators who generated the workflows while previously troubleshooting an issue. For example, when diagnosing an issue for a first time, an administrator may document the steps taken to diagnose the issue using a triage workflow interface of the triage service 100, shown in more detail in FIG. 3. The workflows are stored in a library and tagged with attribute information which indicate scenarios to which a workflow is applicable. The triage service 100 can tag and then identify applicable workflows based on the type of issue detected (e.g., network connection, low memory, high processor load), a type of device (e.g., server, router, switch), an application which is experiencing the issue (e.g., a web server, a video conferencing service, an operating system), etc. The triage service 100 presents the applicable workflows and can recommend one or more of the workflows for the experienced issues. The recommendations can be based on user reviews of the workflows, a number of times a workflow has been selected, how many attributes of the workflow matches the current scenario (e.g., issue type, device type), etc. In FIG. 1, the triage service 100 presents the router workflow 110 as the recommended workflow for resolving the issue at the router 105. The triage service 100 may have also presented workflows for the computers 107 and 108 but indicated the router workflow 110 as the recommended workflow.

The router workflow 110 includes steps which a user/administrator can walk through for troubleshooting the issue at the router 105. As the user navigates through the steps, the triage service 100 presents relevant information for the steps to aid the user in troubleshooting. At the step “check status of connected routers” of the router workflow 110, the triage service 100 retrieves and presents status information for each of the connected routers. The triage service 100 can utilize the topology 101 to identify the relevant devices, i.e., the connected routers in this instance. The triage service 100 can retrieve the status information from another network service or may poll the routers. At the step “check metrics for each router,” the triage service 100 presents metrics for the routers which can be retrieved from an event management service or other metrics/event log. At the step “change router configurations,” the triage service 100 can present the current configurations of the routers and can present suggested/expert recommended configurations for the routers, identify configurations known to cause router issues, etc. For some steps, the triage service 100 may present a user interface component which allows the user to perform an action for the step. For example, the triage service 100 may present a form field for changing router configurations at the “change router configurations step.” For the step “reset non-operational routers,” the triage service 100 may present a “reset” button which a user can select to cause the triage service 100 to execute a script for resetting the non-operational router.

The steps of the router workflow 110 can be presented in coordination with the topology 101. For example, for the step “check status of connected routers,” the triage service 100 may graphically highlight (e.g., enlarge, make bold, change the color) each of the routers in the topology 101 for which the triage service 100 is presenting status information. Additionally, the triage service 100 may modify the topology 101 to display relevant performance metrics for the routers.

After the issue has been resolved or the user otherwise exits the router workflow 110, the triage service 100 can prompt a user for feedback regarding the router workflow 110. The feedback may be binary (e.g., “did this workflow solve your issue? yes/no”) or may be based on a rating system (e.g., 0-5 stars or a 1-10 rating). The feedback can also include which router configurations were changed so that these changes can be presented on subsequent runs of the workflow for other users. Feedback can also include whether the user performed any steps not represented in the workflow. The triage service 100 may allow the user to add the additional step(s) to the router workflow 110 or may automatically add the step if a threshold number of users have indicated that they also performed the additional step.

The triage service 100 can include a machine learning system (not depicted) which records user selections, inputs, and feedback to the router workflow 110 and the triage service 100. The gathered information can be used by the triage service 100 to improve the workflows and identify successful workflows. For example, metrics presented in connections with workflow steps may be associated with a user rating form/interface (e.g., a checkbox which a user can check, a scale which a user can adjust or select such as 5 stars) which a user can use to indicate if the presented metrics were helpful or not helpful. The triage service 100 can use the feedback on the presented metrics to refine which metric types should be presented for a particular step on subsequent executions of the workflow. Additionally, the triage service 100 tracks user paths through a workflow and can determine the most commonly used paths. For example, if a workflow includes a decision block such as the “routers operational?” block of the router workflow 110, the triage service 100 can indicate that 60% of the time users select no and 40% of the time users select yes. Additionally, after a threshold number of executions of a workflow, the triage service 100 may remove steps which are never/rarely executed or steps which fail to resolve existing issues.

The triage service 100 can also modify existing workflows for devices in a network being triaged. For example, if the router workflow 110 included a step for checking the status of connected switches, the triage service 100 can remove the step since the topology 101 indicates that the current network does not include any switches. Additionally, workflows may include steps that correspond to particular network issues or alarms and can be removed if the issue is not present. For example, a workflow for troubleshooting the database 103 may include a step related to determining whether the database 103 has low available storage. If no alarms or metrics indicate low storage for the database 103, the triage service 100 may remove the corresponding step from the workflow.

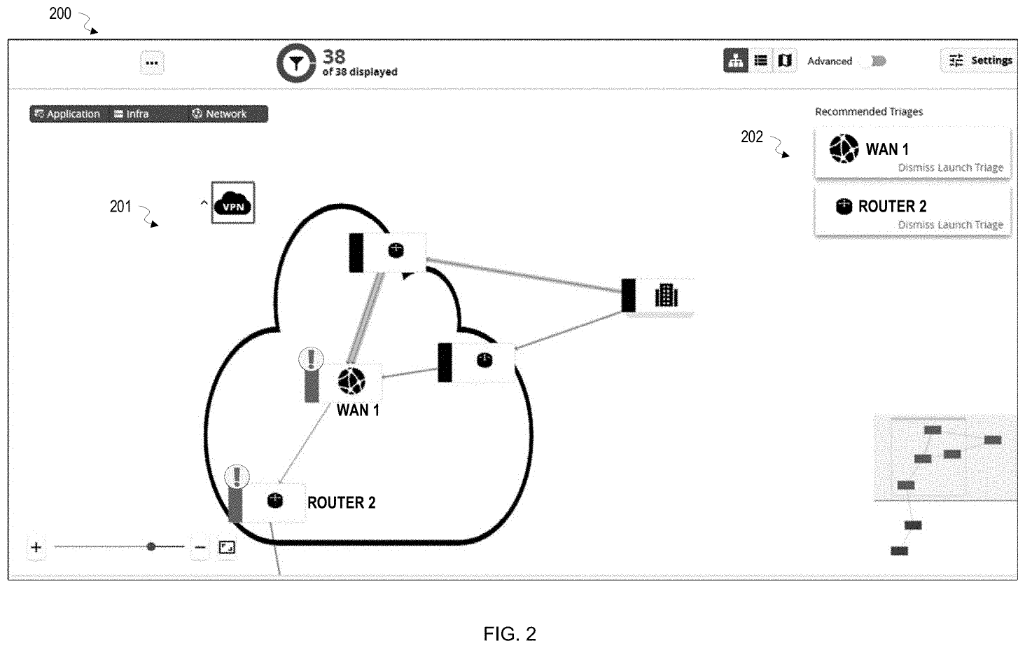

FIG. 2 depicts an example user interface for a triage service which depicts a topology along with recommended triage workflows. FIG. 2 depicts a user interface 200. The interface 200 includes a topology 201 and recommended triage workflows 202. The topology 201 indicates that the “Router 2” and the “WAN 1” are experiencing issues. The workflows 202 include a recommended triage workflow for the “WAN 1” and a recommended triage workflow for the “Router 2” which can be selected by a user.

FIG. 3 depicts an example user interface for a triage workflow editor. FIG. 3 depicts a user interface 300 that includes a workflow 301, workflow requirements 302, and workflow elements 303. The workflow 301 may have been constructed by a user by dragging and dropping blocks from the workflow elements 303. A user can also enter descriptions for each block of the workflow 301. For example, the user may have input the description for the decision block labeled “Inbound or Outbound?” and the “Check Physical Status and Neighbors” block. For some of the blocks in the workflow 301, a user may select from a prepopulated list various metrics to be displayed. For example, for the “CPU/Mem/Disk” block, a user may select metrics related to the CPU, memory, and disk input/output for a device being troubleshooted. Additionally, as shown at the top of the interface 300, a user may choose an existing triage as a starting template for creating a triage workflow which can prepopulate some of the blocks shown in the workflow 301. During the creation of the workflow 301, a user can also specify device types, identifiers for particular devices, events, metrics, etc., to which the workflow 301 applies. The workflow requirements 302 indicate rules for workflow creation including that a triage workflow must have a start element and an end element. After the workflow has been generated, the workflow may be stored in a library or database along with the attributes indicated for the workflow. The workflow may be stored as a extensible markup language (XML) file, a JavaScript Object Notation (JSON) document, a linked list, a graph data structure, or other data structure which indicates the blocks and the connections between them.

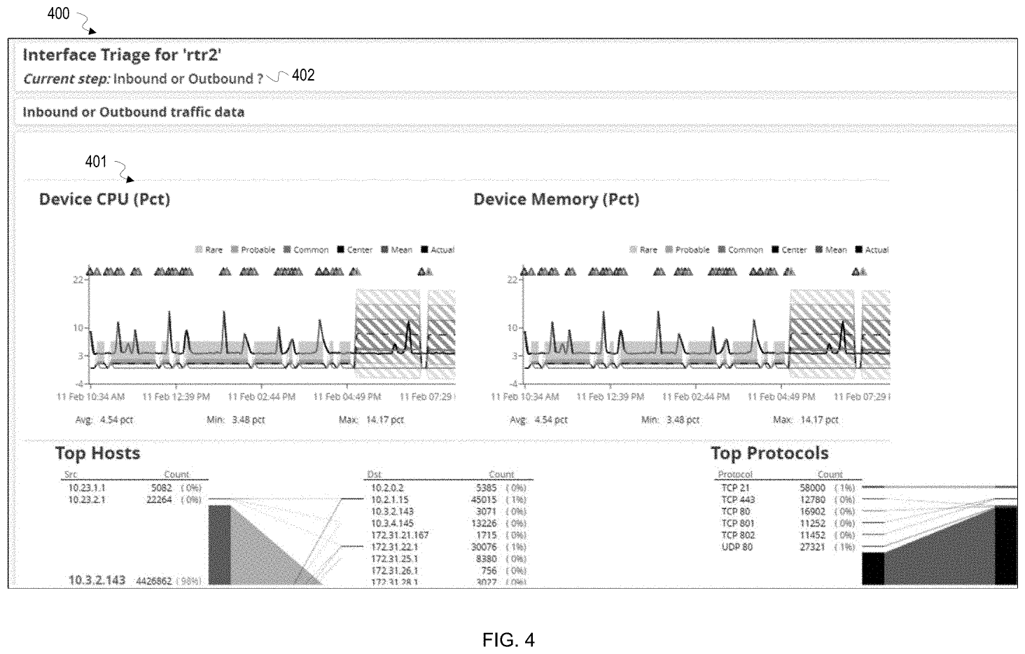

FIG. 4 depicts an example user interface for displaying performance metrics related to a triage workflow. FIG. 4 depicts a user interface 400 that includes metrics 401 relevant to a triage step 402. As shown at the top of the interface 400, the current triage step 402 is related to determining whether an issue is with inbound or outbound traffic. The metrics 401 include information which may aid a user in making the determination. In some implementations, metrics in the metrics 401 which have been previously indicated in user feedback as helpful or relevant may be highlighted or otherwise emphasized. Additionally, on subsequent executions of a workflow, metrics in the metrics 401 which have been previously indicated in user feedback as not helpful or relevant may be removed or hidden and only displayed on additional user interaction (e.g. clicking a dropdown meu).

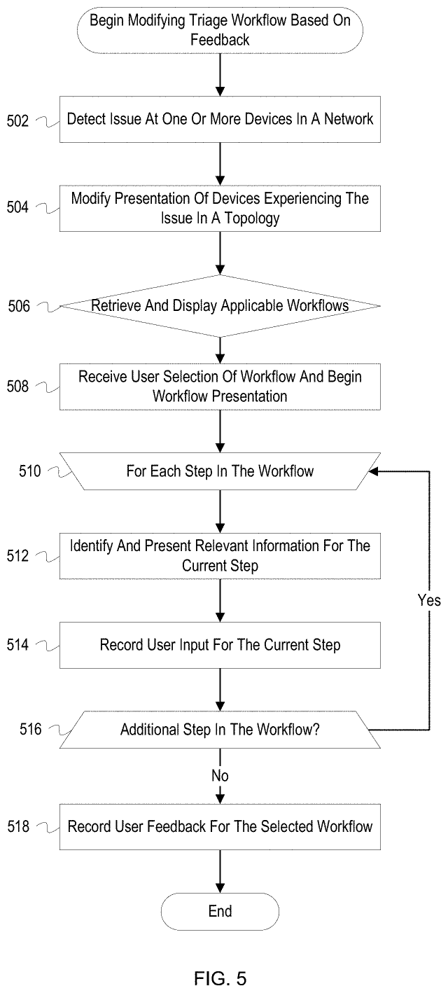

FIG. 5 depicts operations for a topology-based presentation of triage workflows. FIG. 5 refers to a triage service as performing the operations for naming consistency with FIG. 1, although the naming of program code can vary among implementations.

A triage service (“service”) detects an issue at one or more devices in a network (502). The service can monitor events in a network or subscribe to network management software to receive alarms or notifications indicating issues in the network. The service can process events to identify anomalous events which indicate a network issue. An anomalous event is an event that indicates a network occurrence or condition that deviates from a normal or expected value or outcome. For example, an event may have an attribute value that exceeds or falls below a determined threshold or required value, or an event may indicate that a component shut down or restarted prior to a scheduled time. Additionally, an anomalous event may be an event that indicates a network issue such as a component or device failure. The service identifies one or more devices associated with the issue. The service can, for example, extract device identifiers from event indications.

The service modifies presentation of devices experiencing the issue in a topology (504). The service displays a topology of devices in a network. The devices can include network devices such as routers and switches; endpoints such as storage systems, servers, computers; wireless devices such as laptops and cellphones; etc. The devices can also include software such as virtual machines, web applications, etc. The service can display a topology in a user interface and allow a user to interact with the topology by zooming in and out on devices or domains within the topology, selecting a device or connection between devices to display relevant metrics, etc. When an issue has been detected, the service can highlight (e.g. make bold, change the color of a device icon, add an indicator to the device icon, zoom in on the device icon) devices related to the issue. The service may highlight the device at which the issue is occurring and highlight related devices, such as neighboring devices or devices of a same type. Neighboring devices are those devices which are connected to the issue device in the topology. By highlighting the issue device and related devices, the service allows a user to easily identify the devices which are experiencing or are affected by the issue and the network location of the issue.

The service retrieves and displays applicable workflows (506). The service retrieves previously generated workflows which can be used to diagnose or triage the issue. The service can retrieve workflows using attributes or tags of the issue occurring in the network or the device(s) experiencing the issue. For example, the service may retrieve a workflow using a device type of the device experiencing the issue or an identifier for the device. Additionally, workflows can be associated with performance metric types or values. For example, a workflow may be applicable when the processor load of a device exceeds a threshold. The service displays the retrieved workflows and may order them in the display from most recommended to least recommended. Whether a workflow is recommended can be based on previous user feedback or based on a number of attributes which match between the current issue and the workflow. For example, a first workflow that has three matching attributes with a current issue (e.g., device type, issue type, and metric type) can be given a higher recommendation than a workflow with only two matching attributes.

The service receives a user selection of a workflow and begins presentation of the workflow (508). The service can detect an input such as a mouse click or keyboard input indicating a selection of a workflow. The service may display an overview of the selected workflow and pull up a window for displaying relevant information for steps of the workflow.

The service begins operations for each step in the workflow (510). The service iterates through the steps of the workflow and may traverse paths of the workflow in response to user input. Additionally, the service may automatically skip steps or select certain paths based on current system conditions. For example, if a step relates to an event which is not occurring in the system, the service may skip that step. As an additional example, if a decision step relates to a performance metric, the service may automatically select the correct branch by analyzing the relevant performance metrics, e.g., the service may select a “high processor load” branch if the processor load exceeds a threshold. The step which the service is currently presenting is hereinafter referred to as “the current step.”

The service identifies and presents relevant information for the current step (512). The service can display/highlight the devices or connections in the topology which relate to the current step such as a set of routers or connections therebetween. The related devices may be devices indicated in the current step, devices experiencing an issue, devices which are of the same type as the devices experiencing the issue, or devices which are connected to the devices experiencing the issue. The service can retrieve and display relevant performance metrics for the current step. For example, if the step relates to network traffic, the service can retrieve and display metrics such as packets per second. The current step in the workflow can be associated with one or more metric types. In order to retrieve the metrics, the service can also use the topology or another resource to determine identifiers for the devices relevant to the current step. The service uses the metric types and device identifiers to retrieve the relevant metrics from another monitoring service or from a database.

The service records user input for the current step (514). The service can monitor user input and interactions with the displayed information for the current step. The service can also present a form or other interface to allow a user to provide feedback about the current step, such as whether the step was helpful/not helpful, confusing, lacked relevant information, etc.

The service determines if there is an additional step in the workflow (516). If there is an additional step in the workflow, the service selects the next step (510). The service can receive a user selection for navigating the workflow, so the next step selected for display may be determined based on a user selecting the step or choosing a branch leading to the step.

If there is not an additional step in the workflow, the service records user feedback for the selected workflow (518). In addition to receiving feedback for each step, the service can receive user feedback for the workflow overall which may affect the order in which workflows are recommended in the future. If a user indicates in the feedback that the issue was not resolved, the service can recommend other workflows which a user can select and execute. The service can also allow a user to edit the workflow or utilize user feedback to improve the workflow by adding/omitting steps, including additional information for steps, etc.

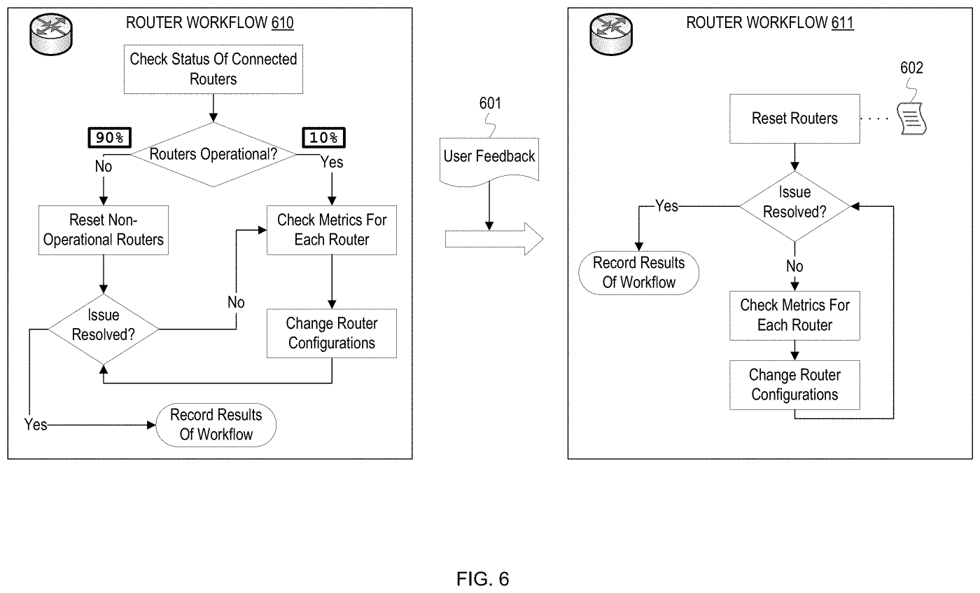

FIG. 6 depicts a triage workflow which has been modified based on user feedback. FIG. 6 depicts a router workflow 610 which is modified based on user feedback 601 to generate a router workflow 611. The router workflow 610 depicts statistics for the workflow 610 which indicate the frequency with which users have traversed paths in the workflow 610. As shown at the “routers operational?” decision block, the statistics indicate that 90% of the time users select the “No” branch of the decision block and only 10% of the time users select the “Yes” branch. These statistics may be part of the user feedback 601 as well as other information regarding feedback from users such as which blocks/steps were skipped by a user, user input for the blocks, general feedback such as whether a step was helpful, etc. Using the user feedback 601, a triage service can optimize the workflow 610. As shown in the workflow 611, the service has moved the “Reset Routers” step to the beginning of the workflow. Since this was shown in the user feedback 601 to be a step selected 90% of the time, the service moved the step to earlier in the workflow 611 which may allow a user to resolve an issue sooner and without having to first traverse unnecessary steps. The service may select a step for optimization once a threshold number of users have utilized a workflow and a selection percentage for a step exceeds a threshold. For example, once at least 100 users have executed a workflow, the triage service may begin reorganizing the workflow to prioritize steps whose selection threshold exceeds 85%. In addition to prioritizing steps with a high selection rate, steps with a low selection rate may be deprioritized or eliminated. For example, a step with a selection rate of less than 15% may be moved to the end of the workflow or may be placed in a list of additional troubleshooting steps presented at the end of a workflow in instances where a user was unable to resolve an issue.

The router workflow 611 also includes a script 602 associated with the reset routers step. The triage service can automatically generate scripts for performing common steps in a workflow. For the script 602, the triage service can generate a PowerShell script or JavaScript process which automates the sending of reset commands to routers in a network. The triage service can dynamically populate the script with Internet Protocol (IP) address of the routers to be reset, i.e., the routers currently experiencing an issue. A user may selectively execute the script 602 (e.g., through clicking a user interface element for the script 602), or the triage service may automatically execute the script 602 upon a user's selection of the workflow 611. A script may be added to a workflow by a user during the generation or editing of a workflow. The triage service allows a user to add program code for a script and enter dynamic fields to be populated by the triage service at runtime of the workflow or script. For example, pseudo code for a script may read “reset [router_IP] if [packets_per_second] is greater than 1000.” At runtime of the workflow, the triage service can populate the dynamic field [router IP] with the IP address of the router at issue and can populate the [packets_per_second] field with the current packets per second metric value of the router.

As a workflow is refined, the triage service can automate execution of a workflow to eliminate or require minimal user interaction. For example, the “change router configurations” step may be automated once optimal or default router configuration settings are determined or are entered by a user. Once each step is associated with a script or is capable of being automated, the triage service can execute a workflow in response to a user's selection of the workflow or upon detection of an event/issue which can be resolved by the workflow.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 504 and 506 can be performed in parallel or concurrently. With respect to FIG. 5, block 514 is not necessary. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

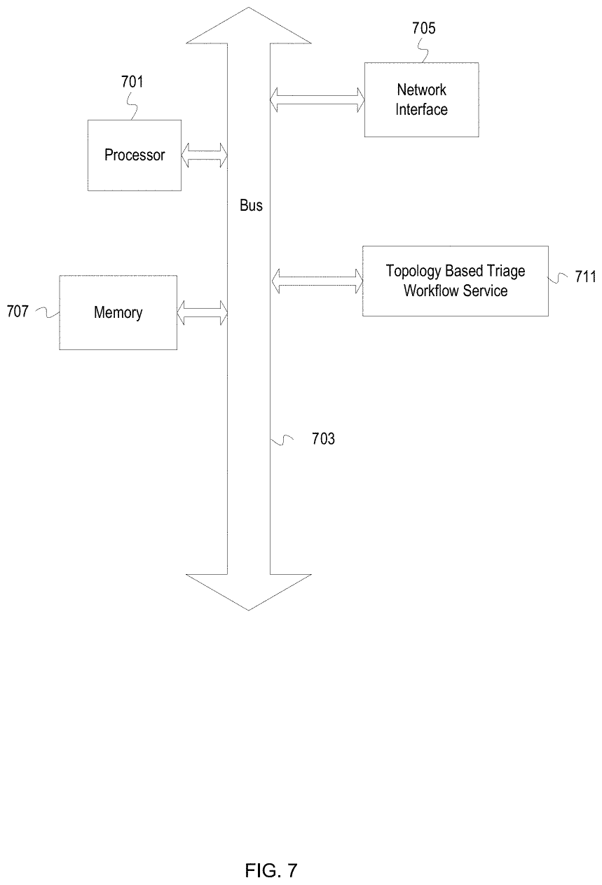

FIG. 7 depicts an example computer system with a topology based triage workflow service. The computer system includes a processor unit 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes topology based triage workflow service 711. The topology based triage workflow service 711 presents and steps through triage workflows for resolving issues in a network. The workflows are presented in coordination with performance metrics and a topology representing devices in a network. Any one of the previously described functionalities may be partially (or entirely) implemented in hardware and/or on the processor unit 701. For example, the functionality may be implemented with an application specific integrated circuit, in logic implemented in the processor unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701 and the network interface 705 are coupled to the bus 703. Although illustrated as being coupled to the bus 703, the memory 707 may be coupled to the processor unit 701.

While the aspects of the disclosure are described with reference to various implementations and exploitations, it will be understood that these aspects are illustrative and that the scope of the claims is not limited to them. In general, techniques for presenting and improving topology-based triage workflows as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on detection of a first issue at a first device, updating a graphical representation of a topology presented in a user interface to emphasize the first device in the graphical representation;
displaying identifiers for triage workflows applicable to the first issue at the first device; and
based on selection of a first of the identifiers corresponding to a first of the triage workflows, presenting a first step of the first triage workflow, wherein presenting the first step of the first triage workflow comprises:
updating the graphical representation of the topology to also emphasize a second device relevant to the first step; and
retrieving and presenting performance metrics for the second device relevant to the first step.

2. The method of claim 1 further comprising:
monitoring user interactions with the first triage workflow; and
modifying the first triage workflow based, at least in part, on the user interactions.

3. The method of claim 2, wherein modifying the first triage workflow based, at least in part, on the user interactions comprises:
determining that the user interactions indicate that a second step of the first triage workflow is selected a percentage of times over executions of the first triage workflow; and
based on determining that the percentage satisfies a threshold, modifying the first triage workflow to present the second step prior to the first step.

4. The method of claim 2, wherein modifying the first triage workflow based, at least in part, on the user interactions comprises displaying additional performance metrics on a subsequent presentation of the first step of the first triage workflow.

5. The method of claim 1, wherein displaying the identifiers for the triage workflows applicable to the first issue at the first device comprises:
determining a recommendation level for each of the triage workflows applicable to the first issue at the first device; and
displaying the identifiers for the triage workflows an order corresponding to the determined recommendation levels.

6. The method of claim 5, wherein a recommendation level is based, at least in part, on a number of matching attributes between a triage workflow and at least one of the first device and the first issue.

7. The method of claim 1, wherein retrieving and presenting performance metrics for the second device relevant to the first step comprises:
determining an identifier for the second device;
determining one or more performance metric types indicated in the first step; and
retrieving the performance metrics for the second device using the identifier and the performance metric types.

8. The method of claim 1, wherein emphasizing the first device in the graphical representation comprises at least one of changing a color of the first device, marking the first device with an icon, and increasing a size of the first device relative to other devices in the graphical representation.

9. The method of claim 1 further comprising updating the graphical representation of the topology to emphasize devices related to the first device, wherein the devices related to the first device are at least one of devices of the same type as the first device, devices affected by the first issue, and devices connected to the first device.

10. One or more non-transitory machine-readable media comprising program code, the program code to:
based on detection of a first issue at a first device, present in a user interface a first step of a first triage workflow applicable to the first issue at the first device;
update a graphical representation of a topology to emphasize the first device;
present in the user interface in association with the first step at least one of performance metrics, device status information, and recommended configuration settings for the first device;
based on detection of a user selection of a second step, present in the user interface the second step of the first triage workflow; and
modify the graphical representation of the topology to emphasize a second device relevant to the second step.

11. The machine-readable media of claim 10 further comprising program code to, based on detection of the user selection of the second step, record the user selection of the second step in user feedback data.

12. The machine-readable media of claim 11 further comprising program code to modify the first triage workflow based, at least in part, on the user feedback data, wherein the program code to modify the first triage workflow based, at least in part, on the user feedback data comprises:
determining that the user feedback data indicates that the second step of the first triage workflow is selected a percentage of times over executions of the first triage workflow; and
based on a determination that the percentage satisfies a threshold, modifying the first triage workflow to present the second step prior to the first step.

13. The machine-readable media of claim 10, wherein the first step is associated with a script for performing operations for the first step, wherein the script comprises dynamic fields which are populated with at least one of an identifier of the first device, the performance metrics, and the recommended configuration settings for the first device.

14. The machine-readable media of claim 10, wherein the at least one of performance metrics, device status information, and recommended configuration settings for the first device presented in association with the first step are each associated with a user rating interface, wherein user input of the user rating interfaces is stored in user feedback data.

15. An apparatus comprising:
a processor; and
a machine-readable medium having program code executable by the processor to cause the apparatus to,
based on detection of a first issue at a first device, update a graphical representation of a topology presented in a user interface to emphasize the first device in the graphical representation;
display identifiers for triage workflows applicable to the first issue at the first device;
based on selection of a first of the identifiers corresponding to a first of the triage workflows, present a first step of the first triage workflow, wherein the program code to present the first step of the first triage workflow comprises program code to:
update the graphical representation of the topology to also emphasize a second device relevant to the first step; and
retrieve and present performance metrics for the second device relevant to the first step; and
monitor user interactions with the first triage workflow; and
modify the first triage workflow based, at least in part, on the user interactions with the first triage workflow.

16. The apparatus of claim 15, wherein the program code to modify the first triage workflow based, at least in part, on the user interactions comprises program code to:
determine that the user interactions indicate that a second step of the first triage workflow is selected a percentage of times over executions of the first triage workflow; and
based on a determination that the percentage satisfies a threshold, modify the first triage workflow to present the second step prior to the first step.

17. The apparatus of claim 15, wherein the program code to modify the first triage workflow based, at least in part, on the user interactions comprises program code to display additional performance metrics on a subsequent presentation of the first step of the first triage workflow.

18. The apparatus of claim 15, wherein the program code to display the identifiers for the triage workflows applicable to the first issue at the first device comprises program code to:
determine a recommendation level for each of the triage workflows applicable to the first issue at the first device; and
display the identifiers for the triage workflows an order corresponding to the determined recommendation levels.

19. The apparatus of claim 18, wherein a recommendation level is based, at least in part, on a number of matching attributes between a triage workflow and at least one of the first device and the first issue.

20. The apparatus of claim 15, wherein the program code to emphasize the first device in the graphical representation comprises program code to at least one of changing a color of the first device, marking the first device with an icon, and increasing a size of the first device relative to other devices in the graphical representation.
